(19) United States
(12) Patent Application Publication
(10) Pub. No.: US 2008/0033813 A1
(43) Pub. Date: Feb. 7, 2008

(54) System and Method For Generating Business Referrals

(75) Inventor: Ara Khachatryan, Brooklyn, NY (US)

Correspondence Address: EDWARD ETKIN, ESQ., Law Office of Edward Etkin, PC, 228 West End Avenue, Suite A, Brooklyn, NY, 11235, US

(73) Assignee: KHACHARA, INC., Brooklyn, NY (US)

(21) Appl. No.: 11/733,750

(22) Filed: Apr. 10, 2007

Related U.S. Application Data
(60) Provisional application No. 60/791,546, filed on Apr. 11, 2006.

(51) Int. Cl. G06Q 30/00

(52) U.S. Cl. 705/14

(57) ABSTRACT

The present invention provides a system and method for encouraging employees of a business to refer customers to one or more predetermined other businesses that (or that have a predetermined business relationship with their employer), thus increasing overall sales of the entity. Generation of referrals is implemented through a system of trackable referral tokens that are provided to employees of each business of the entity to be given to customers. The referral tokens list predetermined participating businesses of the entity and optionally provide a customer reward for patronizing the listed businesses when the token is used at any of the listed businesses. Each referral token is uniquely associated with a particular employee, such that when the token is presented at a listed business, the particular employee may be credited with the referral. One or more reward systems may be provided for rewarding employees making referrals in accordance with the quantity and/or quality of their referrals. Tracking of the referrals may be implemented in a variety of ways, with different levels of automation. In the preferred embodiment, each referral token includes device-readable data encoding, and each participating businesses of the entity is provided with devices capable of reading the encoded data from referral tokens and communicating each referral (along with ID of referring employee) to a central referral tracking system which may be liked to a reward system for issuing rewards to referring employees.

### CROSS REFERENCE TO RELATED APPLICATION

The present patent application claims priority from the commonly assigned U.S. Provisional Patent Application Ser. No. 60791,546 entitled “System and Method for Generating Business Referrals” filed Apr. 11, 2006.

### FIELD OF THE INVENTION

The present invention relates generally to a data processing system and method for encouraging employees of a business to refer customers of the business to one or more other predetermined businesses, and more particularly to a data processing system and method for implementing and tracking referrals made by business employees and, when the referrals are successful rewarding the corresponding referring employees.

### BACKGROUND OF THE INVENTION

Increasing sales is a constant goal for any business, and as a result many approaches are utilized to increase the number of customers patronizing the business. Among the most popular approaches are engaging in advertising and implementing promotions that provide incentives to customers. However, it is well established that one of the best sources of customers are referrals that direct the customer to a particular business.

In cases where an entity owns two or more related businesses (e.g., restaurants, etc.) it is very advantageous to generate referrals of satisfied customers from one business to one or more of the other businesses. For this reason, employees of the businesses are often asked to make such referrals. In other cases, the request for referral comes from satisfied customers themselves. For example, in cities with tourism, visitors that dine in a restaurant they enjoyed and who do not know other establishments well, may ask their server for a referral to other equally good restaurants. Unfortunately, there is nothing that motivates the server to direct the customers to a related business. And even f a referral to a related business is made, it is impossible to track the follow of referred customers to appraise the synergy between the various businesses. Moreover, a simple referral to a customer does not necessarily mean that the customer will actually follow the referral—the customer has no incentive to do so.

It would thus be desirable to provide a system and method for encouraging employees of a business to refer customers of the business to one or more predetermined other businesses that are owned by the same entity (or by an allied business entity), thus increasing overall sales of the entity, by rewarding the employees for successful referrals. It would also be desirable to provide a system and method for tracking successful referrals by issuing referrers and to track the flow of the referrals between various businesses. It would further be desirable to provide a system and method for rewarding the customers for following the referrals,

### BRIEF DESCRIPTION OF THE DRAWINGS

In the drawings, wherein like reference characters denote corresponding or similar elements throughout the various figures:

FIG. 1 shows a block diagram of an exemplary embodiment of the inventive data processing system for generating referrals from one business to another;

FIG. 2 shows a diagram of an exemplary embodiment of a referral token utilized in the inventive data processing system of FIG. 1;

FIG. 3 shows a block diagram of an exemplary embodiment of a referral receipt component of the inventive data processing system of FIG. 1 and of utilization thereof;

FIG. 4 shows a process flow diagram of exemplary embodiment of processes for referral generation, referral token use and referral reward, executed at least partially by the data processing system of FIG. 1; and

FIG. 5 shows a block diagram of an exemplary embodiment of a referral token reading system of the referral receipt component of FIG. 4, and of utilization thereof.

### SUMMARY OF THE INVENTION

The inventive system and method provide a novel business referral infrastructure that encourages employees of a business to refer customers to one or more predetermined other businesses that are owned by the same entity (or that have a predetermined business relationship with their employer), thus increasing overall sales of the entity (and/or of the businesses that have formed a referral relationship).

Generation of referrals is implemented through a system of trackable referral items or “tokens”, (such as paper, plastic, or metal cards) that are provided to employees of each business of the entity to be given out to customers. Each referral tokens preferably lists predetermined participating businesses of the entity (and/or of the business alliance), and optionally provides a customer reward for patronizing the listed businesses, when the token is used at any of the listed businesses.

Advantageously, each referral token is uniquely associated with a particular employee, such that when the token is presented at a listed business, the particular employee may be credited with the referral. One or more reward systems may be provided for rewarding employees making referrals in accordance with the quantity and/or quality of their referrals. Tracking of the referrals may be implemented in a variety of ways, with different levels of automation. In the preferred embodiment, each referral token includes device-readable data encoding, and each participating businesses of the entity (and/or of the business alliance) is provided with devices capable of reading the encoded data from referral tokens and communicating each referral (along with ID of referring employee) to a local or central referral tracking system, which may be liked to one or more reward systems for issuing rewards to the employees making successful referrals.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The present invention provides a system and method for encouraging employees of a business to refer customers of the business to one or more predetermined other businesses that are owned by the same entity, thus increasing overall sales of the entity. In an alternate embodiment of the invention, the referrals to businesses not owned by the entity may be generated, based on prior arrangements made therebetween.

In essence, the present invention facilitates referrals from one business to one or more additional businesses having a relationship therewith (for example: common ownership partnership, joint venture, or any other form of a business alliance and/or cooperation). This is accomplished by encouraging employees of each business, that interact with customers of that business, to refer customers to one or more other predetermined businesses, and optionally provides a reward claimable by the customers if they patronize any of the predetermined businesses. In turn, the inventive system keeps track of successful referrals by each employee, so that referring employees may be rewarded in accordance with one or more predetermined reward systems.

Besides the readily apparent advantages of increasing the flow of customers and revenues for businesses that participate in the novel referral system, the system and method of the present invention have additional peripheral advantages of improving employee performance and customer service. Employees who know they can be rewarded for making successful referrals will ensure that their level of customer service is such, that the customer would be more likely to consider and follow their referral.

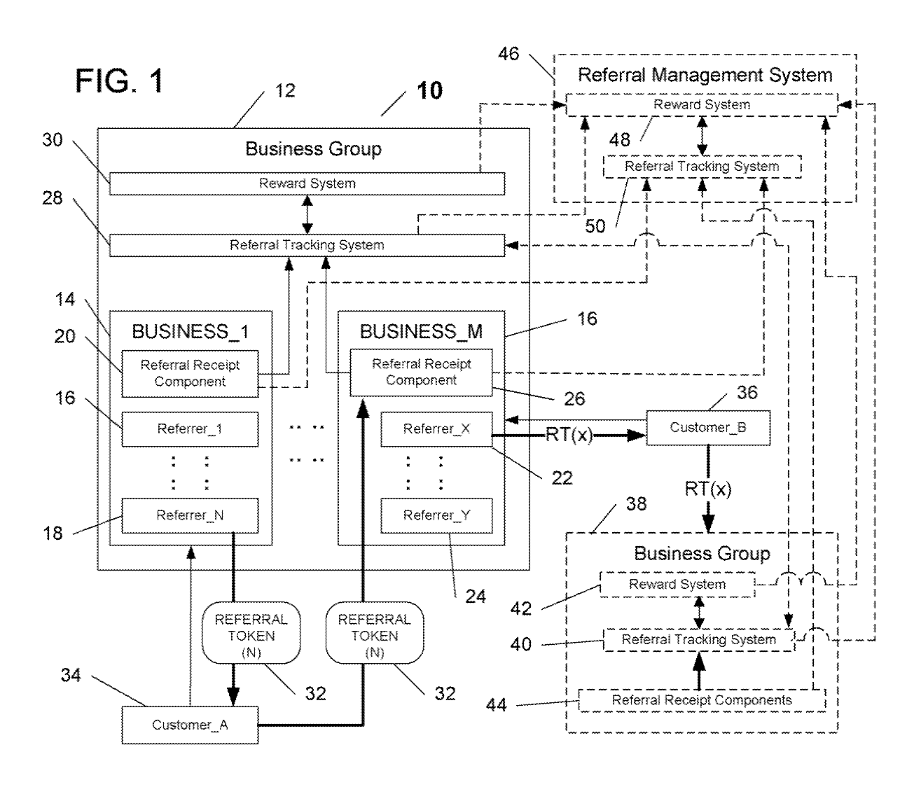

Preferably, the above novel process of referrals is implemented through a system of trackable referral items (hereinafter referred to as “tokens”) that are provided to employees of each business of the entity, and that may be given to customers by each employee (as shown in FIGS. 1-5, and as described in greater detail below). Each referral token, which is preferably implemented as a card (plastic, paper or metal), lists predetermined participating businesses of the entity (or optionally of other businesses having a predetermined business relationship with the entity) and, optionally, may provide a predetermined customer reward for patronizing the listed businesses when the token is used at any of the listed businesses (e.g., if the businesses are restaurants, the reward may be a free drink, a free desert, etc.). As a matter of design choice, the customer reward may be listed on the token itself, or, the reward may be determined by the business in which the token is presented.

Each referral token is uniquely associated with a particular employee, for example listing that employee's name and/or ID, such that when the token is presented at a listed business, the particular referring employee may be credited with the referral. One or more reward systems may be provided for rewarding employees making referrals in accordance with the quantity and/or quality of their referrals. Tracking of the referrals, and thus identification of referring employees, may be implemented through various embodiments, with different levels of automation. In the preferred embodiment, each referral token includes device-readable data encoding and each participating businesses of the entity (or of a multi-business alliance) is provided with devices capable of reading the encoded data from referral tokens and communicating each referral (along with the ID of each referring employee), to a local and/or to a central referral tracking system which may be liked to one or more reward systems for issuing rewards to referring employees.

The referral tracking and referrer reward processes of the present invention mentioned above and described in greater detail below, are key novel elements that distinguish the inventive system and method from previously known referral programs—in conventional programs, the customer presenting a referral card is rewarded, but the flow of referrals is not tracked or monitored and most importantly, the individual making the referral is not rewarded for making the referral (thus having no reason other than their good nature to make the referral in the first place).

Referring now to FIG. 1, an exemplary embodiment of the inventive system for generating referrals is shown as a referral system 10. In one inventive embodiment, the referrals are desirable between businesses of a Business Group 12 which may include two or more businesses, shown by way of example as BUSINESS_1 14 through BUSINESS_M 16. Business Group 12 may be any group of two or more businesses with a predefined relationship therebetween (for example an entity that owns two or more businesses (such as a holding company), or an alliance of businesses (such as a local merchant's association)). The businesses that are part of the Business Group 12 may be any form of business in which employees (Referrer_1 16 to Referrer_N 18) interact with customers (e.g., Customer_A 34), and have an opportunity to refer a customer (such as, by way of example, the Customer_A 34) to another business. For example, BUSINESS_1 14 to BUSINESS_M 16 may be restaurants, bars or clubs, hotels, or they may be retail stores, parking garages, or any combination thereof. Of course businesses in which employees have extended interaction with customers (such as between servers and diners in a restaurant) are likely to draw a greater advantage from the inventive system.

Each Referrer 16 to 18 and 22 to 24 (i.e., employees of BUSINESSes 14, 16) is preferably provided with a REFERRAL TOKEN 32 by a party authorized by at least one of the corresponding BUSINESS 14, 16, or by the Business Group 12. For example, the authorized party may be the Referrer's supervisor, the manager of the BUSINESS by which the referrer is employed, a manager of the Business Group 12, or a third party agent authorized by the management of the Business Group 12 to issue REFERRAL TOKENS.

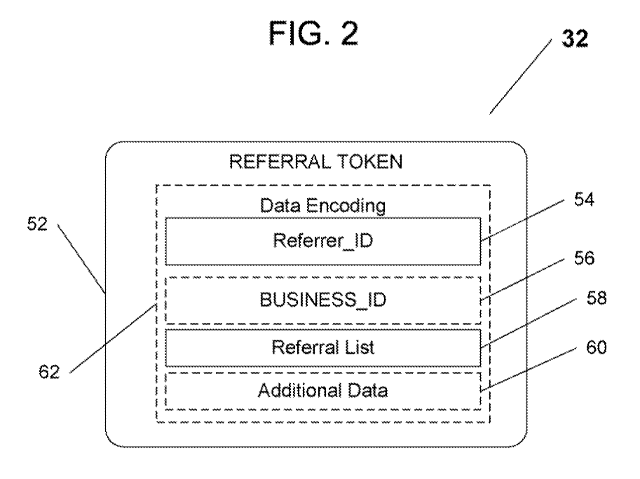

Referring now to FIG. 2, the REFERRAL TOKEN 32 includes a body 52 (for example, a card made from paper, plastic, metal, or a combination of materials), and preferably identifies the individual Referrer, to whom the REFERRAL TOKEN 32 is issued, with a Referrer_ID 54 (such as listing the Referrer's name, and, optionally a predetermined ID code unique to the Referrer), and may also optionally identify the BUSINESS from which the TOKEN 32 originates, with a BUSINESS_ID 56. The TOKEN 32 also lists one or more participating BUSINESSES, in which the REFERRAL TOKEN 32 may be presented by the customer, as a Referral List 58. Finally, the TOKEN 32 may have one or more items of Additional Data 60, such as listing a customer reward for presenting the TOKEN 32 in one of the BUSINESSES listed in the Referral List 58, which may be a predetermined reward (e.g., free drink in a restaurant, or a certain percentage discount from purchase), or a non-specific reward that may change from time to time, or from BUSINESS to BUSINESS.

The Additional Data 60 may include other information, such as an expiration date for the TOKEN 32, or contact information for the BUSINESS issuing the TOKEN, or of the Business Group 12. The TOKEN 32 may also include decorative elements, such as a color picture or pictures, decorative lettering, and/or embossing. In accordance with the present invention, one or more of the information elements 54-60, may be positioned on a front side of the TOKEN 32, or on its back side, as a matter of design choice. Each element 54-60 may be applied to the TOKEN 32 utilizing one or more techniques, including, but not being limited to, printing, embossing, engraving, applying an adhesive sticker, etc.

Preferably at least a portion of the information items 54-60 are also encoded in a device-readable format (such as a barcode (or other image-based scannable code), RFID, magnetic strip, microchip, etc.), and stored in and/or printed on the TOKEN 32, as data encoding 62. While printed information items 54-60 are readily readable by a person, the use of data encoding 62 enables quick and automated tracking of referrals in the referral system 10.

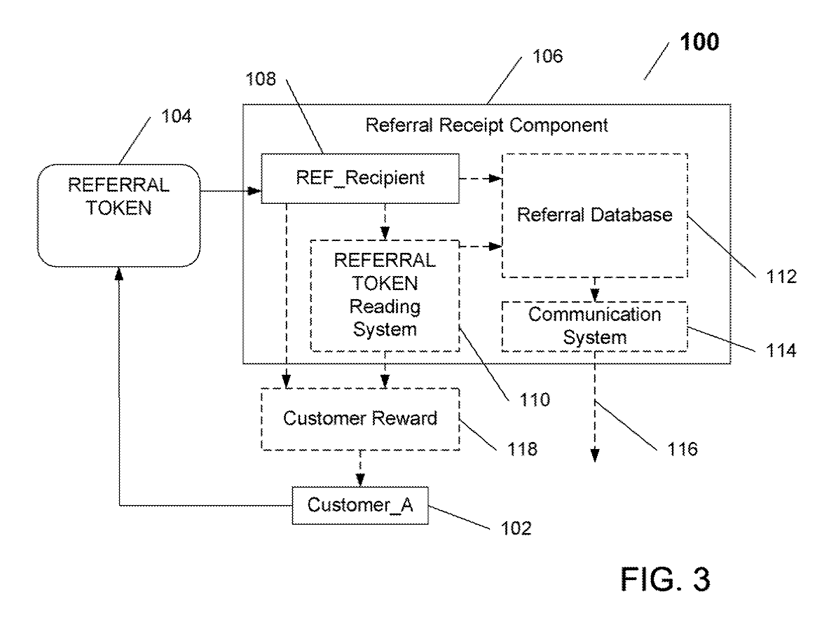

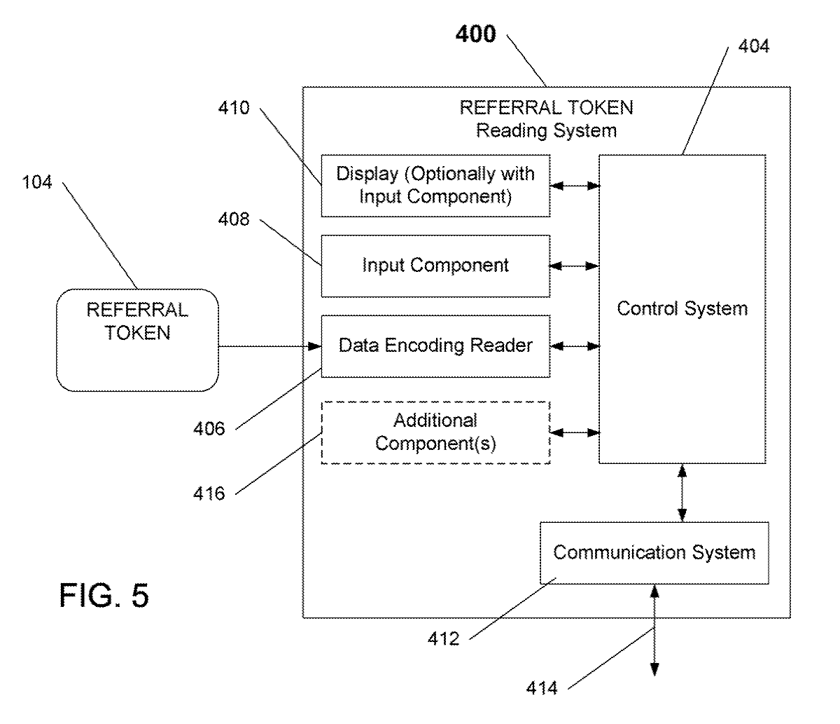

Returning to FIG. 1, each BUSINESS 14 to 16 is provided with a corresponding referral receipt component 20, 26, respectively. Each referral receipt component 20, 26 (described in greater detail In conjunction with FIG. 3 below), is configured for receiving the REFERRAL TOKEN 32, for authorizing the issue of customer rewards, and for tracking the Referrer_ID of the Referrer providing the received TOKEN 32 to the customer. The referral receipt components 20, 26 communicate with a referral tracking system 28 (such as a local or a remote database, which may be implemented on a local area or a wide area network of the Business Group 12, or which may be Internet-based), and ensure that the referral tracking system 28 receives information about each successful referral, so that each Referrer is properly credited with successful referrals. Preferably, each referral receipt component 20, 26 is equipped with a REFERRAL TOKEN reading system that automatically reads the TOKEN 32 presented thereto, in case the TOKEN 32 includes data encoding 62. An exemplary REFERRAL TOKEN reading system 400 is shown in FIG. 5 and described in greater detail below in connection therewith.

Each referral receipt component 20, 26 may be implemented and operated manually, or, preferably, in conjunction with one or more automated steps performed by data processing devices. For example, the referral receipt component 20, 26 may range from an authorized person, at the BUSINESS receiving the referral, writing down the Referrer information, from the REFERRAL TOKEN 32 presented to them by the Customers_A 34, in a reward ledger, to the authorized person entering the Referrer information from the TOKEN 32 into a computerized referral tracking system 28, to the authorized person running a TOKEN 32, having data encoding therein (a magnetic strip, RFID, etc.) through a reader which extracts the Referrer information (and optionally other information) from the TOKEN 32 and sends it automatically to the referral tracking system 28.

The Business Group 12 also preferably includes a reward system 30, that communicates with the referral tracking system 28: and that issues appropriate rewards to the Referrers 16, 18, 22, 24, based on successful referrals made by them (i.e., based on TOKENs issued by them being submitted by customers at participating BUSINESSes). A wide variety of various possible reward systems may be utilized as the reward system 30, for example issuing points to the Referrers for each successful referral made by them, with the points being redeemable for anything of value including, but not limited to: cash, meals, services, trips, products, paid time off, promotion eligibility, etc.

In an alternate embodiment of the invention, in addition to tracking the referral itself, the referral receipt component may track the amount of money spent by the referred customer, and transmit information representative of that amount to the referral tracking system 28 for the purpose of tracking the degree of success of the operation of the system 10 or passed to another database or system that analyses business data. Optionally, the referral reward system 30 may base the reward awarded to the referrer for a successful referral on the amount of money spent by the referred customer (for example, awarding redeemable referral points at a predetermined ration to the money spent by the referred customer). The referral tracking system 28 and/or the reward system 30 may be implemented and/or operated by the Business Group 12, or they may be implemented and/or operated by a third party authorized to do so by the management of the Business Group 12.

Optionally, in another embodiment of the present invention, the referral system 10 may include support for referrals between the Business Group 12 and one or more additional Business Groups 38, having their own referral tracking system 40, reward system 42, and referral receipt components 44. The referral and reward process is handled in each Business Group as described above, except that the referral tracking systems preferably communicate with one another to ensure proper crediting of referrals. In one alternate inventive embodiment, the Business Groups 12 and 38 each have their own respective reward systems 30, and 42, respectively. Optionally, the Business Groups 12, 38 may share a single reward system (e.g., the reward system 30) that receives referral tracking information from all referral tracking systems 28, 40.

In another inventive embodiment, involving multiple Business Groups, rather than each Business Group 12, 38 having their own referral tracking systems (28, 40), and/or their own reward systems (30 and/or 42), the Business Groups 12, 38 communicate with a remote centralized referral management system 46 that is utilized to provide centralized tracking of all referrals within, and between, each Business Group 12, 38 via a central referral tracking system 50. The centralized referral management system 46 may also include a centralized reward system 48, that may be utilized to administrate and provide rewards for all Referrers of the Business Groups 12, 38. The centralized referral management system 46 may be operated by one or more personnel appointed by the management of the Business Groups 12, 38, or, it may be operated by a third party for the benefit of the Business Groups 12, 38.

Referring now to FIG. 3, an exemplary embodiment of the referral receipt components 20, 26, is shown as a referral receipt operation 100 of a referral receipt component 106. In the operation 100, when a customer 102 presents a REFERRAL TOKEN 104 to the referral receipt component 106, the TOKEN 104 is received by a REF_Recipient 108 authorized to receive REFERRAL TOKENs (such as one or more particular employees of the BUSINESS accepting the referral (e.g., the host, supervisor, manager, etc.)). If the TOKEN 104 includes data encoding, a REFERRAL TOKEN reading system 110 is used to read the data from the TOKEN 104, and then pass the obtained information to a referral database 112 (e.g. for later batch uploading to the referral tracking system 28), or directly to a communication system 114 that forwards the data to the referral tracking system 28 via a communication link 116 (e.g., internet, phone line, etc.). If the TOKEN 104 does not include data encoding, then the REF_Recipient 108 may enter the appropriate data from the TOKEN 104 manually into the referral database 112, or for direct transmission to the referral tracking system 28 by the communication system 114.

When the TOKEN 104 is submitted, the customer reward 118 is preferably issued to the customer 102, either directly by the REF_Recipient 108 (e.g., by causing a free drink to be brought to the customer 102), or by the reading system 110 automatically (e.g., by causing a discount to be applied to the bill of customer 102).

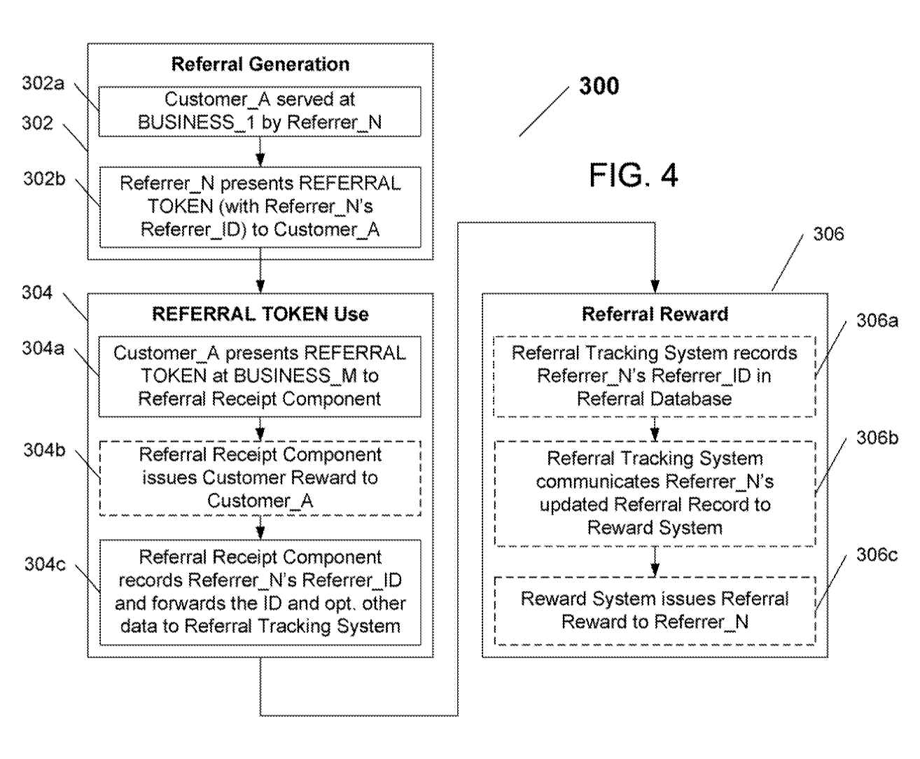

Referring now to FIG. 4, an exemplary embodiment of the various processes 300 of the referral system 10 is shown. The referral processes occur in three general stages—referral generation 302, REFERRAL TOKEN use 304, and referral reward 306. The various steps occurring at each stage are shown in FIG. 4 with optional steps being indicated with a dashed line.

At the referral generation stage 302, at a step 302a, a Customer_A served at BUSINESS_1 by a Referrer_N, and at a step 302b, the Referrer_N presents REFERRAL TOKEN (with Referrer_N's Referrer_ID) to Customer_A. At a later point in time, at the REFERRAL TOKEN use stage 304, at a step 304a, Customer_A presents the REFERRAL TOKEN to a Referral Receipt Component at a BUSINESS_M. At a step 304b, the Referral Receipt Component issues a Customer Reward to Customer_A, and at a step 304c, the Referral Receipt Component records Referrer_N's Referrer_ID and forwards the ID and optionally other data to a Referral Tracking System. At the referral reward stage 306, at a step 306(a), the Referral Tracking System records the Referrer_N's Referrer_ID in Referral Database, at a step 306b, the Referral Tracking System communicates Referrer_N's updated Referral Record to a Reward System, and at a step 306c, the Reward System issues a Referral Reward to the Referrer_N.

Referring now to FIG. 5, an exemplary embodiment of the REFERRAL TOKEN reading system 110 of FIG. 3 is shown as a REFERRAL TOKEN reading system 400. Preferably, the REFERRAL TOKEN reading system 400 is a custom configured data processing system (or a conventional data processing system supplied with the appropriate components) and includes a control system 404 for controlling the operation thereof, a data encoding reader 406 for reading data (such as the Referrer_ID) from the REFERRAL TOKEN 104 presented thereto. a The type and configuration of the data encoding reader 406 depends on the type of data encoding utilized in the REFERRAL TOKEN 104. For example, if the encoding is a magnetic strip, then the data encoding reader 406 is a magnetic strip reader, if the encoding is a barcode, then the data encoding reader 406 is a barcode scanner, etc. Optionally, the data encoding reader 406 may include two or more date encoding readers so that REFERRAL TOKENS of different encoding types could be read.

The REFERRAL TOKEN reading system 400 also includes an input component (such as a keyboard or keypad) for entering information therein manually, and a display component 410, such as a screen, which displays various information relevant to operation of the referral system 10, such as the data obtained from the REFERRAL TOKEN 104 by the data encoding reader 406. Optionally, the display component 410 may incorporate the input component 408 in whole or in part if the display component 410 is configured as touchscreen or equivalent.

The REFERRAL TOKEN reading system 400 further includes a communication system 412 (which may be a substitute for, or be in addition to, the communication system 114 of FIG. 3) capable of transmitting the Referrer_ID, and other data read from each REFERRAL TOKEN by the data encoding reader 406, to a remote system (such as the referral tracking system 28 of FIG. 1) via a communication link 414, which may be a wired or wireless internet connection, a local or wide area network connection, or any other type of connection to a communication network. The communication system 412 may also send information or instructions to other systems in the BUSINESS, for example instructing a restaurant management system not to charge a particular customer for a drink (as part of the customer's reward). Finally, the REFERRAL TOKEN reading system 400 includes one or more additional components 416, which may include, for example, a security system that restricts the use of the system 400 to the authorized REF Recipient 108 (of FIG. 3).

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing method for generating referrals of a customer between a plurality of business entities by at least one employee of at least a portion of the plural business entities, comprising the steps of:
(a) providing a referral token to the at least one employee, said referral token being redeemable at at least one plural business entity;
(b) selectively providing said referral token, by the at least one employee to the customer;
(c) redeeming said referral token by the customer, at said at least one plural business entity; and
(d) tracking said redemption made at said step (c), and crediting the at least one employee of said step (a) with a successful referral.
